(19) United States
(12) Patent Application Publication
(10) Pub. No.: US 2016/0042128 A1
(43) Pub. Date: Feb. 11, 2016

(54) METHOD, SYSTEM AND COMPUTER PROGRAM PRODUCT FOR MOBILE ACTIVATION OF ACCESS TO PERSONAL MEDICAL RECORDS

(71) Applicant: Bon Secours Health System, Inc., Marriottsville, MD (US)

(72) Inventors: Samantha Krigsvold, Richmond, VA (US); Matthew Schertz, Virginia Beach, VA (US)

(21) Appl. No.: 14/822,584

(22) Filed: Aug. 10, 2015

Related U.S. Application Data
(60) Provisional application No. 62/034,882, filed on Aug. 8, 2014.

(51) Int. Cl. G06F 19/00; H04W 8/20; H04W 4/14

(52) U.S. Cl. CPC G06F 19/322; H04W 4/14; H04W 8/205

(57) ABSTRACT

To authenticate a user and create an account for a web-based portal, an electronic medical record system generates a unique activation code and uses SMS gateways to send encrypted an activation code in an embedded URL to a user's mobile communication device. The user then authenticates with a custom web application and creates account on a patient web portal to the EMR system.

### BACKGROUND OF THE INVENTION

The present invention relates generally to electronic record access and retrieval systems, and in particular relates to patient access to personal electronic medical or healthcare records (EMRs or EHRs) via a mobile communication device such as a smartphone.

MyChart by Epic Systems Corporation is an integrated patient health record (PHR) system that gives patients controlled access to their medical records through an internet browser. MyChart provides a number of functions, such as allowing patients to view test results, view upcoming and past medical appointments, fill out pre-visit questionnaires, schedule appointments, view paperless statements and pay bills online, upload photos, update medications and allergies, connect to home devices, refill prescriptions, message securely with providers, view a child's records and print growth charts, manage the care of elderly parents, and view education topics triggered by EHR data.

While MyChart also provides a mobile application, privacy and security concerns require pre-authentication and authorization of a patient's smartphone before the patient is able to use the mobile application. Also, many functions of the MyChart application are not available on the mobile application version. What is needed is a method for secure activation of a patient account from a smartphone, wherein a patient may establish a web portal account and download a mobile PHR application directly from their smartphone or other mobile communication device.

### SUMMARY OF THE INVENTION

In accordance with the invention, a method, system and computer program product are provided to authenticate a user and create an account for a web-based portal. An electronic medical record system generates a unique activation code and uses SMS gateways to send an encrypted activation code in an embedded URL to a user's mobile device. The user then authenticates with a custom web application on their healthcare provider's server, and creates an account on a patient portal. The user then may download a mobile PHR application to obtain access to their personal health and medical records from their healthcare provider.

In particular, in accordance with one aspect of the invention, a method is provided for activating a mobile communication device of a patient to have access to electronic medical records of the patient, comprising: receiving a request for activation of a mobile communication device of a patient, said request being initiated through a link in a medical report of said patient; in response to said request, creating an activation code and associating said activation code with a telephone number of said mobile communication device; sending said activation code to said mobile communication device using said telephone number; receiving a communication from said mobile communication device in response to sending said activation code; and in response to verification of the validity of said response, creating a user account for said patient and associating the user account with said mobile communication device; whereby said patient is provided with access to said patient's electronic medical records through said mobile communication device.

In accordance with another aspect of the invention, a system is provided for activating a mobile communication device of a patient to have access to electronic medical records of the patient, comprising: an electronic medical record application server, configured to receive a request for activation of a mobile communication device of a patient, said request being initiated through a link in a medical report of said patient; an electronic medical record database configured to generate, in response to a query from said application server, activation code data and associate said activation code with a telephone number of said mobile communication device; a message gateway server configured to send said activation code to said mobile communication device using said telephone number; a Web server configured to receive a communication from said mobile communication device in response to sending said activation code; and a Web Services gateway server configured to create a user account for said patient and associate the user account with said mobile communication device; whereby said patient is provided with access to said patient's electronic medical records through said mobile communication device.

In accordance with yet another aspect of the invention, a non-transitory computer-readable medium is provided having stored thereon computer-executable instructions for activating a mobile communication device of a patient to have access to electronic medical records of the patient, comprising instructions for causing a computer to: receive a request for activation of a mobile communication device of a patient, said request being initiated through a link in a medical report of said patient; generate, in response to a query from said application server, activation code data and associate said activation code with a telephone number of said mobile communication device; send said activation code to said mobile communication device using said telephone number; receive a communication from said mobile communication device in response to sending said activation code; and create a user account for said patient and associate the user account with said mobile communication device; whereby said patient is provided with access to said patient's electronic medical records through said mobile communication device.

### BRIEF DESCRIPTION OF THE DRAWINGS

FIG. 1 is a schematic diagram illustrating one example of a process flow for smartphone activation of a patient health record account and smartphone authentication in accordance with one aspect of the invention;

FIG. 2 is a screenshot of a user's smartphone display, showing a text message with embedded link for smartphone activation in accordance with the invention;

FIG. 3 is a screenshot of a user's smartphone display, showing a patient activation window for creation of a patient PHR account in accordance with the invention;

FIG. 4 is a schematic diagram of an example system structure in accordance with another aspect of the invention; and

FIG. 5 is a flow diagram illustrating a workflow process for patient account establishment and smartphone authentication in accordance with another aspect of the invention.

### DETAILED DESCRIPTION OF THE INVENTION

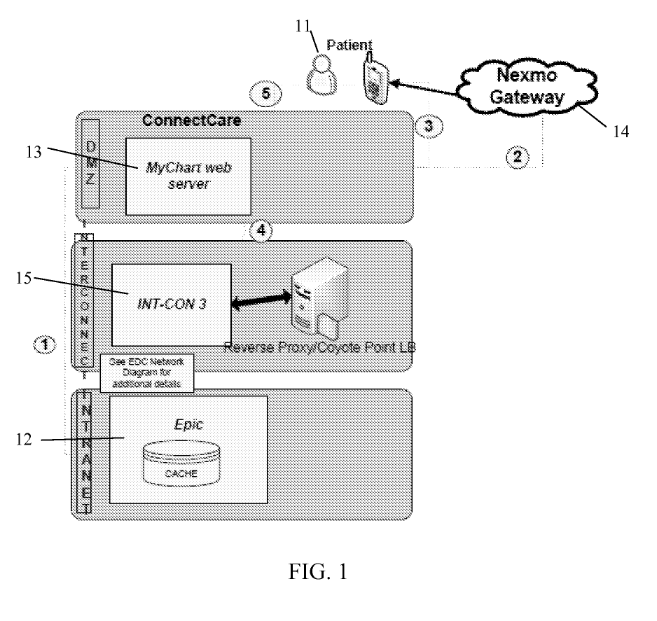

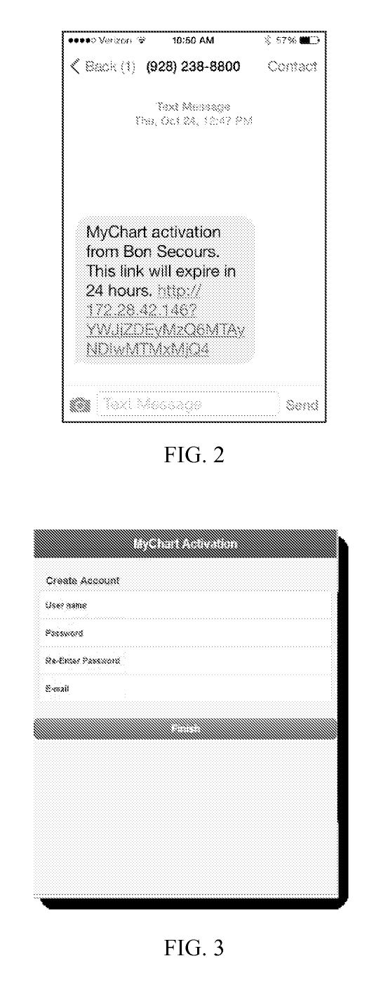

FIG. 1 illustrates a process flow for PHR smartphone authentication and activation in accordance with one aspect of the invention. A user initiates a smartphone activation request for the smartphone of a patient 11, from within an EMR in a PHR system 12 (such as Epic for example), at step 1. The request redirects to a custom ASP page on a PHR server 13 (such as e.g. MyChart). The custom ASP page then generates an activation code and a creation time for the activation code, encrypts the activation code (using, for example, BASE64), and sends it to an SMS gateway such as Nexmo Gateway 14, at step 2. The SMS gateway then sends to the smartphone of the patient 11 a text message containing a link, and the encoded activation code and creation time, to the user's smartphone. An example of the text message is shown in FIG. 2.

The patient 11 then clicks on the link in the text message displayed on the patient's smartphone, and is thereby redirected to the custom ASP page on the server 13, at step 3. The patient is then directed on the custom ASP page to enter authentication information, such as the last four digits of the patient's Social Security Number (SSN), the patient's date of birth (DOB), or other secure information. If the patient's access to the server 13 is within a predefined period of time after the creation time (such as, for example, 3 hours), at step 4 the ASP sends the patient's credentials via a CreatePatientAccount web service to an Interconnect server 15. The web service submits an XML object containing the activation code and the patient's authentication data to the server. The Interconnect server 15 returns to the ASP on server 13 a validation response if all the information is valid. All communications with the Interconnect server are done via reverse proxy server such as Coyote Point LB. At step 5, the custom ASP page collects a user name and password from the patient 11 via the patient's smartphone as shown in FIG. 3, and sends this information back to the Interconnect server 15 via an ActivateAccount web service. The service then establishes a patient account with the user name and password and associates the account with the telephone number of the patient's smartphone. The patient may then open or download a mobile application providing access to the patient's personal medical records directly from the PHR server.

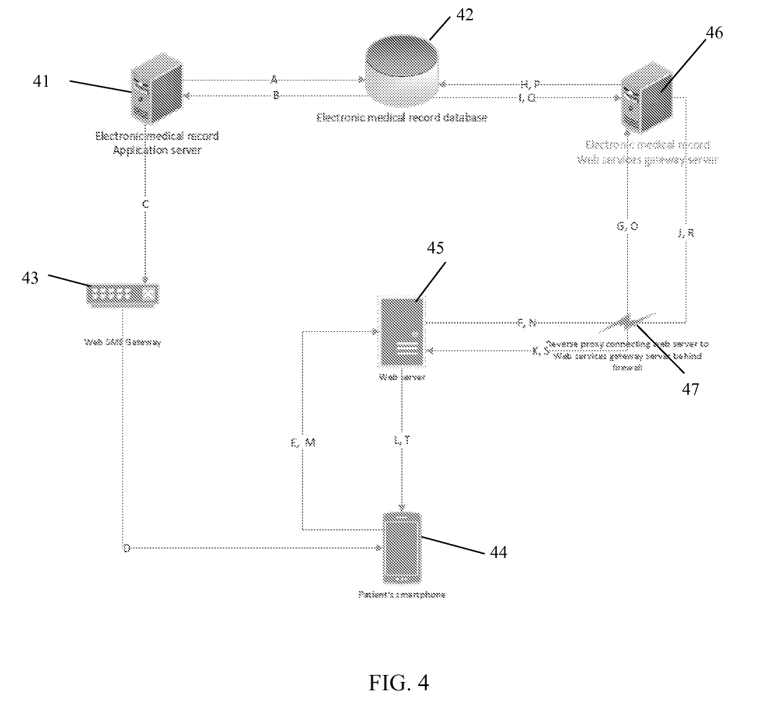

FIG. 4 shows an example system structure in accordance with another aspect of the invention. A staff member initiates a request from a patient's electronic medical record in EMR server 41 to send a message to the patient. A query (A) is sent to the database 42 for an activation code and the telephone number(s) of the patient's mobile communication device(s). The database 42 returns a unique activation code (B) specific to the patient as well as any mobile numbers on file, to the application server 41. The application server 41 then generates a JavaScript Object Notation (JSON) message containing the unique activation code, a link to a Web server 45, and the time that the message was generated, encoded in BASE64, and sends it to the Web short message service (SMS) gateway 43 via HTTP post using secure socket layers (SSL).

The web SMS gateway 43 then sends an SMS message (D) to a telephone number of a patient's mobile communication device 44 as returned from the EMR database 42. The patient then taps the touch-sensitive phone display to open the link. This generates a request (E) to the Web server 45, which contains the unique activation code and the time of generation. The Web server 45 validates the code if it is not expired according to the received creation time. The Web server 45 then forwards the activation code (F) to the reverse proxy server 47 as an XML SOAP request. The reverse proxy server 47 then forwards the SOAP request (G) to Web services gateway server 46 (behind the firewall). The Web services gateway server 46 then forwards the activation code (H) to the electronic medical record database server 42. The database 42 then checks the code and returns either an “invalid” message or a patient ID (I) to the Web services gateway server 46. The Web services gateway server 46 then creates an XML SOAP response containing either the invalid error message or patient ID (J) and forwards it to the reverse proxy server 47.

The reverse proxy server 47 then forwards the XML SOAP response (K) to a JSON object on Web server 45 and returns it to the patient's smartphone 44 (L). The smartphone 44 shows either the error message or a screen (see FIG. 3) to create a username and password. The patient's inputted username, password, and security questions are then sent as JSON (M) to Web server 45. Web server 45 then creates an XML SOAP request containing the patient's inputted username, password and security questions and sends it (N) to the reverse proxy server 47. The reverse proxy server 47 then forwards the XML SOAP request (O) to the Web services gateway server 46 behind the firewall. The Web services gateway server 46 then forwards the patient's requested username, password and security questions (P) to the database 42. The database 42 attempts to create a patient account and returns either an error or an account successful message (Q) and forwards it to the EMR Web services server 46, which forwards it to the reverse proxy server 47 (R). Reverse proxy server 47 then forwards the XML SOAP response to the web server 45 (S). Web server 45 then creates a JSON object containing the error message or activation successful message and returns it (T) to the patient's smartphone 44. If activation was successful, the patient is redirected to the EMR server 41 and prompted to either open or download the PHR mobile application.

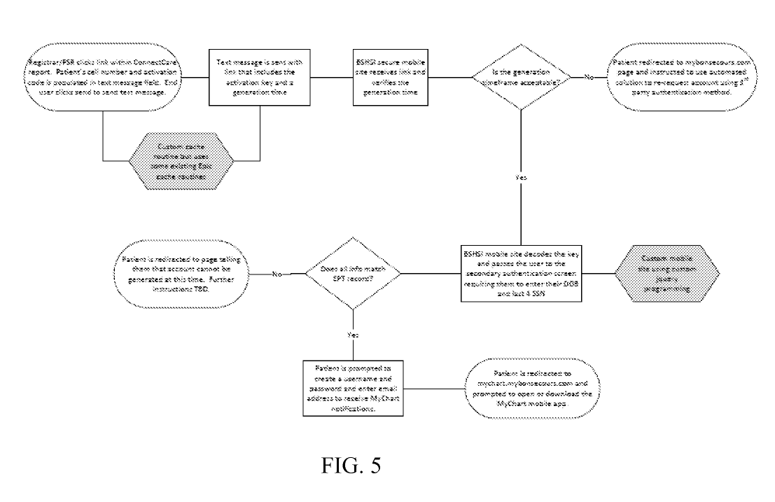

FIG. 5 shows a flow diagram according to another aspect of the invention. The steps are self-explanatory and analogous to the procedures explained above with respect to FIG. 4.

What is claimed is:

1. A method for activating a mobile communication device of a patient to have access to electronic medical records of the patient, comprising:
receiving a request for activation of a mobile communication device of a patient, said request being initiated through a link in a medical report of said patient;
in response to said request, creating an activation code and associating said activation code with a telephone number of said mobile communication device;
sending said activation code to said mobile communication device using said telephone number;
receiving a communication from said mobile communication device in response to sending said activation code; and
in response to verification of the validity of said response, creating a user account for said patient and associating the user account with said mobile communication device;
whereby said patient is provided with access to said patient's electronic medical records through said mobile communication device.

2. The method of claim 1, further comprising associating a creation time with said activation code, wherein verification of the validity of said response comprises comparing the difference between time of receipt of said communication from said mobile communication device and said creation time with a predefined time period.

3. The method of claim 1, wherein sending said activation code comprises sending a SMS message to said mobile communication device.

4. The method of claim 1, further comprising the step of encoding said activation code prior to sending it to said mobile communication device.

5. The method of claim 1, wherein receiving a communication from said mobile communication device is performed by an ASP page on a medical record application server.

6. The method of claim 5, wherein creating an activation code is performed by said ASP page.

7. The method of claim 1, wherein verification of the validity of said response comprises receiving personal information of the patient and comparing it with information stored in a database.

8. The method of claim 7, wherein said personal information comprises at least one of the patient's Social Security Number and the patient's date of birth.

9. The method of claim 1, wherein access to said patient's electronic medical records through said mobile communication device is provided through a mobile application installed on the mobile communication device.

10. A system for activating a mobile communication device of a patient to have access to electronic medical records of the patient, comprising:
an electronic medical record application server, configured to receive a request for activation of a mobile communication device of a patient, said request being initiated through a link in a medical report of said patient;
an electronic medical record database configured to generate, in response to a query from said application server, activation code data and associate said activation code with a telephone number of said mobile communication device;
a message gateway server configured to send said activation code to said mobile communication device using said telephone number;
a Web server configured to receive a communication from said mobile communication device in response to sending said activation code; and
a Web Services gateway server configured to create a user account for said patient and associate the user account with said mobile communication device;
whereby said patient is provided with access to said patient's electronic medical records through said mobile communication device.

11. The system of claim 10, wherein said application server is further configured to associate a creation time with said activation code, wherein verification of the validity of said response comprises comparing the difference between time of receipt of said communication from said mobile communication device and said creation time with a predefined time period.

12. The system of claim 10, wherein said message gateway server is a SMS server configured to send said activation code in the form of a SMS message to said mobile communication device.

13. The system of claim 12, wherein said SMS server is further configured to encode said activation code prior to sending it to said mobile communication device.

14. The system of claim 10, further comprising an ASP page on said medical record application server, said ASP page being configured to receive a communication from said mobile communication device.

15. The system of claim 14, wherein said ASP page is further configured to create an activation code.

16. The system of claim 10, wherein said data is configure to verify the validity of said response by comparing personal information of the patient with information stored in said database.

17. The system of claim 16, wherein said personal information comprises at least one of the patient's Social Security Number and the patient's date of birth.

18. The system of claim 10, wherein access to said patient's electronic medical records through said mobile communication device is provided through a mobile application installed on the mobile communication device.

19. A non-transitory computer-readable medium having stored thereon computer-executable instructions for activating a mobile communication device of a patient to have access to electronic medical records of the patient, comprising instructions for causing a computer to:
receive a request for activation of a mobile communication device of a patient, said request being initiated through a link in a medical report of said patient;
generate, in response to a query from said application server, activation code data and associate said activation code with a telephone number of said mobile communication device;
send said activation code to said mobile communication device using said telephone number;
receive a communication from said mobile communication device in response to sending said activation code; and
create a user account for said patient and associate the user account with said mobile communication device;
whereby said patient is provided with access to said patient's electronic medical records through said mobile communication device.
